(19) United States
(12) Patent Application Publication
(10) Pub. No.: US 2005/0172039 A1
(43) Pub. Date: Aug. 4, 2005

(54) KVM switch

(75) Inventor: David Hsu, Taipei Hsien (TW)

Correspondence Address: BACON & THOMAS, PLLC, 625 SLATERS LANE, FOURTH FLOOR, ALEXANDRIA, VA, 22314, US

(73) Assignee: C&C Technic Taiwan Co., Ltd., Taipei Hsien (TW)

(21) Appl. No.: 10/770,415

(22) Filed: Feb. 4, 2004

(51) Int. Cl. G06F 3/00

(52) U.S. Cl. 710/1

(57) ABSTRACT

A KVM switch having a control circuit mounted inside a housing and formed of a microprocessor, an OSD control circuit, a filtering switching circuit, a mouse control circuit, a keyboard control circuit, and a VGA control circuit, and adapted to receive a plurality of computers and computer peripheral apparatus including a keyboard, a mouse, and a display, the control circuit having a program adapted to selectively control output signal from one computer to the display subject to the operation of pre-set buttons of the connected keyboard or the mouse.

### BACKGROUND OF THE INVENTION

1. Field of the Invention

The present invention relates to a KVM switch and, more particularly, to such a KVM switch, which enables the user to selectively switch one of a set of computers to a display by means of clicking selection from the screen of the display via a keyboard or mouse.

2. Description of the Related Art

Following fast development of computer technology, a variety of high-speed computers have been developed for use to help working efficiency of people. In some cases, several computers may have to be linked for storing and/or processing a big amount of data. When several computers are used, a KVM switch may be necessary for control switching among the computers. However, conventional KVM switches for this purpose are commonly not convenient in use. When wishing to switch from one computer to another, the switching action must be achieved by means of operating the switches at the KVM switch or specific keys at the keyboard. However, different keyboards may have different definitions on the same keys. A conflict may occur when operating one specific key of a keyboard to switch the computers.

### SUMMARY OF THE INVENTION

The present invention has been accomplished under the circumstances in view. It is the main object of the present invention to provide a KVM switch, which enables the user to selectively switch one of a set of computers to a display by means of operating a keyboard or mouse to click selection from the screen of the display.

According to one aspect of the present invention, the KVM switch comprises an electrically insulative housing, and a control circuit mounted inside the housing and adapted to receive a plurality of computers and computer peripheral apparatus including a keyboard, a mouse, and a display. The control circuit comprises a program adapted to selectively control output signal from one of the computers to the display subject to the operation of pre-set buttons of the keyboard and mouse been connected to the control circuit. According to another aspect of the present invention, the control circuit comprises: a microprocessor, which has a control program adapted to connect a keyboard, a mouse, and a plurality of computers; an OSD (ON SCREEN DISPLAY) control circuit connected to the microprocessor and adapted to select display picture subject to the program of the microprocessor; a filtering switching circuit connected to the OSD control circuit and a display and adapted to filter the picture not selected by the OSD control circuit and to switch to the selected signal for enabling the selected signal to be displayed on the display connected thereto; a keyboard control circuit connected to the microprocessor and the computers being connected to the microprocessor to serve as an interface between the microprocessor and the connected computers and to examine and convert the output signal of the keyboard into a format readable to the microprocessor; a mouse control circuit connected to the microprocessor and the computers at the microprocessor to serve as an interface between the microprocessor and the connected computers and to examine and convert the output signal of the mouse into a format readable to the microprocessor; and a VGA control circuit connected to the filtering switching circuit the computers at the microprocessor to serve as an interface between the filtering switching circuit the connected computers and to examine and convert the output signal of the connected computers into a format readable to the filtering switching circuit.

### BRIEF DESCRIPTION OF THE DRAWINGS

FIG. 1 is an elevational view of a KVM switch according to the present invention.

FIG. 2 is a system block diagram of the present invention.

FIG. 3 shows an application example of the present invention.

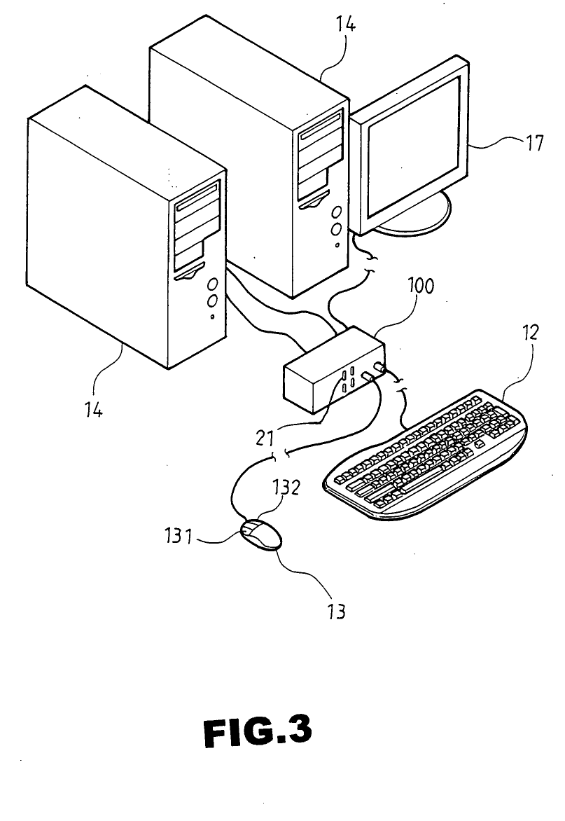

### DETAILED DESCRIPTION OF THE PREFERRED EMBODIMENT

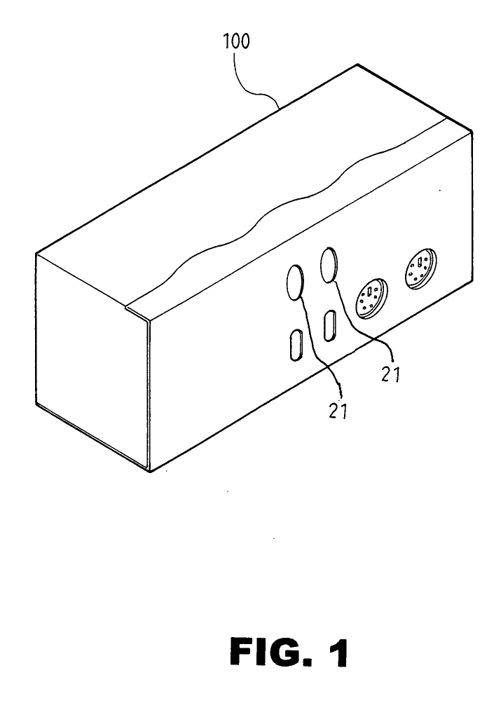

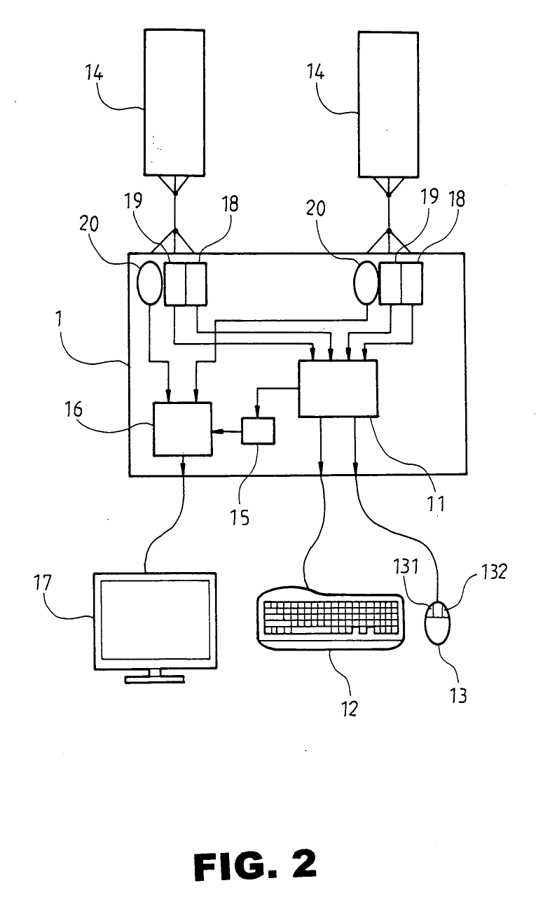

Referring to FIGS. 1 and 2, a KVM switch in accordance with the present invention is shown comprising an electrically insulating housing 100, and a control circuit 1 mounted inside the housing 100.

The control circuit 1 comprises a microprocessor 11, which has a control program adapted to connect a keyboard 12, a mouse 13, and at least two computers 14, an OSD (ON SCREEN DISPLAY) control circuit 15 connected to the microprocessor 11 and adapted to select display picture subject to the program of the microprocessor 11, a filtering switching circuit 16 connected to the OSD control circuit 15 and the display 17. and adapted to filter the picture not selected by the OSD control circuit 15 and to switch to the selected signal for enabling the selected signal to be displayed on the display 17, a keyboard control circuit 18 connected to the microprocessor 11 and the computers 14 to serve as an interface between the microprocessor 11 and the computers 14 and to examine and convert the output signal of the keyboard 12 into a format readable to the microprocessor 11, a mouse control circuit 19 connected to the microprocessor 11 and the computers 14 to serve as an interface between the microprocessor 11 and the computers 14 and to examine and convert the output signal of the mouse 13 into a format readable to the microprocessor 11, and a VGA control circuit 20 connected to the filtering switching circuit 16 and the computers 14 to serve as an interface between the filtering switching circuit 16 and the computers 14 and to examine and convert the output signal of the computers 14 into a format readable to the filtering switching circuit 16.

Based on the aforesaid combination, several computers 14 and other computer peripheral apparatus including a keyboard 12, a mouse 13, a display 17, and etc. are respectively connected to the housing 100 and controlled by the program set in the microprocessor 11, so that the user can operate pre-set keys of the keyboard 12, combination buttons of the mouse 13, or pre-set buttons 21 at the housing 100 to control the operation of the computers 14 individually subject to the operation of the program of the microprocessor 11.

When switched to the keyboard 12, the user can operate the keyboard 12 to control the computers 14 as follows:
Press [Left ctrl]+[Left ctrl] to select last computer;
Press [Right ctrl]+[Right ctrl] to select next computer
Press [F1]-[Fn] to directly select one specific computer;
Press [Scroll Lock]+[Scroll Lock] to enter auto-cruise mode;
Press [ESC] to escape from auto-cruise mode;
Press [win] to start/close mouse-to-computer selection function.

When switched to the mouse 13, the user can directly use the left combination button 131 and the right combination button 132 to select the computers 14.

Either switching to the keyboard 12 or the mouse 13, the display 17 displays data signal from the controlled computer 14, and at the same time the OSD control circuit 15 of the control circuit 1 converts the display picture of the display 17 properly. Therefore, the user can operate the mouse 13 to click switching selection from the picture on the display 17, simplifying the control of the computers 14.

A prototype of KVM switch has been constructed with the features of FIGS. 1˜3. The KVM switch functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

1. A KVM switch comprising an electrically insulative housing and a control circuit mounted inside said housing and adapted to receive a plurality of computers and computer peripheral apparatus including a keyboard, a mouse, and a display, said control circuit comprising a program adapted to selectively control output signal from one of said computers to said display subject to the operation of pre-set buttons of the keyboard and mouse been connected to said control circuit.

2. The KVM switch as claimed in claim 1, wherein the keyboard which is connected to said control circuit in said housing has pre-set button means adapted to switch on/off the mouse being connected to said control circuit in said housing.

3. The KVM switch as claimed in claim 1, wherein the keyboard which is connected to said control circuit in said housing has pre-set button mans for switching on/off the mouse being connected to said control circuit in said housing, and pre-set button means for control switching between the computers and the display.

4. The KVM switch as claimed in claim 1, wherein said control circuit in said housing comprises:
a microprocessor, which has a control program adapted to connect a keyboard, a mouse, and a plurality of computers;
an OSD (ON SCREEN DISPLAY) control circuit connected to said microprocessor and adapted to select display picture subject to the program of said microprocessor;
a filtering switching circuit connected to said OSD control circuit and a display and adapted to filter the picture not selected by said OSD control circuit and to switch to the selected signal for enabling the selected signal to be displayed on the display connected thereto;
a keyboard control circuit connected to said microprocessor and the computers being connected to said microprocessor to serve as an interface between said microprocessor and the connected computers and to examine and convert the output signal of said keyboard into a format readable to said microprocessor;
a mouse control circuit connected to said microprocessor and the computers at said microprocessor to serve as an interface between said microprocessor and the connected computers and to examine and convert the output signal of said mouse into a format readable to said microprocessor; and
a VGA control circuit connected to said filtering switching circuit the computers at said microprocessor to serve as an interface between said filtering switching circuit the connected computers and to examine and convert the output signal of the connected computers into a format readable to said filtering switching circuit.
